(19) United States
(12) Patent Application Publication
(10) Pub. No.: US 2015/0310113 A1
(43) Pub. Date: Oct. 29, 2015

(54) Mobile Terminal, Server, System And Method For Realizing Search

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventor: Lingyun YI, Beijing (CN)

(73) Assignees: Beijing Qihoo Technology Company Limited, Beijing (CN); Qizhi Software (Beijing) Company Limited, Beijing (CN)

(21) Appl. No.: 14/648,168

(22) PCT Filed: Sep. 26, 2013
(86) PCT No.: PCT/CN2013/084275

§ 371 Date: May 28, 2015

(30) Foreign Application Priority Data
Nov. 30, 2012 (CN) 201210506448.1

(51) Int. Cl. G06F 17/30

(52) U.S. Cl. CPC G06F 17/30867; G06F 17/3087; G06F 17/30554; G06F 17/30598

(57) ABSTRACT

The invention discloses a mobile terminal, server, system and method for realizing search, the mobile terminal including: an input module configured to receive a keyword for a search; a transmitting module configured to transmit the keyword to a server; a receiving module configured to receive a recommended search engine and/or application selected by the server according to the keyword; a search module configured to use the recommended search engine to search for the keyword to obtain search results after receiving the recommended search engine; and a presenting module configured to present a page of the search results for the search using the search engine recommended by the server and/or to present the application recommended by the server, when the input module receives the instruction to select the recommended application, instructing the search module to use the application indicated in the instruction to search for the keyword, and after the search results are obtained, presenting the search results. The invention can achieve an advantageous effect of obtaining better search results for a keyword.

### FIELD OF THE INVENTION

The present disclosure relates to the field of communications and particularly to a mobile terminal, server, system and method for realizing search.

### BACKGROUND OF THE INVENTION

In the prior art, when a user inputs a keyword in a search box of a mobile terminal, either an application with a name including the keyword may be entered or a search engine may be used to search for the keyword. Particularly if the keyword is a part of the name of an application or a certain item of content in the application, the mobile terminal would search for the application, a list of installed applications including the keyword is presented. If the keyword is the content to be searched, a default search engine is selected to make a search and a page of search results is presented.

In the prior art, each search is made using the same default search engine. However, there may be different search results in different search engines for the same keyword. For example, when a commodity is searched for, there are significantly difference between the search results using a search engine for a general search and a search engine specific to electronic commercial enterprises. In the prior art, in order to enable all types of keywords could be searched, typically a general search engine is used as a default search engine, thus resulting in a drawback that better search results can not be obtained by using a more appropriate search engine to search the keyword.

### SUMMARY OF THE INVENTION

In view of the problem, the present disclosure has been made to provide a mobile terminal, a server, a system and a method so as to overcome or at least partially solve the problem above.

According to an aspect of the disclosure, there provides a mobile terminal for realizing search, the mobile terminal including: an input module configured to receive a keyword for a search; a transmitting module configured to transmit the keyword to a server; a receiving module configured to receive a recommended search engine and/or application selected by the server according to the keyword; a search module configured to use the recommended search engine to search for the keyword to obtain search results after receiving the recommended search engine; and a presenting module configured to present the page of the search results for the search using the search engine recommended by the server; and/or to present the application recommended by the server, when the input module receives the instruction to select the recommended application, instructing the search module to use the application indicated in the instruction to search for the keyword, and after the search results are obtained, presenting the search results.

According to another aspect of the disclosure, there provides a server for realizing search, the server including: an information receiving module configured to receive a keyword for a search transmitted by a mobile terminal; a recommendation selecting module configured to select the recommended search engine and/or application according to the keyword; and an information transmitting module configured to return the recommended search engine and/or application to the mobile terminal.

According to a further aspect of the disclosure, there provides a system for realizing search in a mobile terminal, the system including the mobile terminal and the server.

According to a further aspect of the disclosure, there provides a method for realizing search in a mobile terminal, the method including: receiving a keyword for a search and transmitting the keyword to a server; receiving a recommended search engine and/or application selected by the server according to the keyword; using the recommended search engine to search for the keyword to obtain search results and presenting a page of the search results after receiving the recommended search engine; and/or presenting the applications recommended by the server, and after receiving an instruction to select a recommended application, using the application indicated in the instruction to search for the keyword and presenting search results.

According to a still further aspect of the disclosure, there provides a method for providing a mobile terminal with a search, the method including: receiving a keyword for a search transmitted by a mobile terminal; selecting a recommended search engine and/or application according to the keyword; and returning the recommended search engine and/or application to the mobile terminal.

Advantageous effects of the disclosure are as follows:

According to the technical solutions of the disclosure, the keyword to be searched for is transmitted to the server, the recommended search engine and/or application selected by the server according to the keyword is received, the search engine or application is used to make a search. Since the search engine or application used to search for the keyword is recommended by the server according to the keyword instead of the same default search engine, the more appropriate search engine or application than the default search engine in the prior art can be used in correspondence to each keyword to realize a search, so that an advantageous effect of obtaining better search results for the keyword is obtained.

The description above is only a summary of the technical solutions of the disclosure, for a better understanding of the technical means of the disclosure, which then can be put into practice according to the disclosure of the description, and in order to make the foregoing and other objects, features and advantages of the disclosure more apparent, specific embodiments of the disclosure will be described below.

### BRIEF DESCRIPTION OF DRAWINGS

Various other advantages and benefits of the disclosure will become apparent to those skilled in the art upon review of the following detailed description of preferred embodiments. The drawings are merely for illustrating the objects of the preferred embodiments but not deemed as the limitation to the disclosure. In addition, the same reference number is used to represent the same component throughout the drawings. Among the drawings:

FIG. 1 illustrates a structural diagram of a mobile terminal for realizing search according to an embodiment of the disclosure;

FIG. 2 illustrates a structural diagram of a mobile terminal for realizing search according to an embodiment of the disclosure;

FIG. 3 illustrates a structural diagram of a mobile terminal for realizing search according to an embodiment of the disclosure;

FIG. 4 illustrates a schematic diagram of an interface presenting search results according to an embodiment of the disclosure;

FIG. 5 illustrates a structural diagram of a server for realizing search according to an embodiment of the disclosure;

FIG. 6 illustrates a structural diagram of a server for realizing search according to an embodiment of the disclosure;

FIG. 7 illustrates a structural diagram of a system for realizing search according to an embodiment of the disclosure;

FIG. 8 illustrates a flow chart of a method for realizing search in a mobile terminal according to an embodiment of the disclosure;

FIG. 9 illustrates a flow chart of a method for realizing search in a mobile terminal according to an embodiment of the disclosure;

FIG. 10 illustrates a flow chart of a method for providing a mobile terminal with search according to an embodiment of the disclosure;

FIG. 11 illustrates schematically a block diagram of a server for performing the method according to the disclosure; and

FIG. 12 illustrates schematically a storage unit holding or carrying program codes for performing the method according to the disclosure.

### DETAILED DESCRIPTION OF THE INVENTION

Exemplary embodiments of this disclosure will be described below in further details with reference to the drawings. Although the exemplary embodiments of this disclosure are illustrated in the drawings, it shall be understood that this disclosure can be carried out in various forms and should not be limited to the embodiments described here. On the contrary, these embodiments are provided to enable this disclosure to be understood thoroughly and to enable the full scope of this disclosure to be conveyed to those skilled in the art.

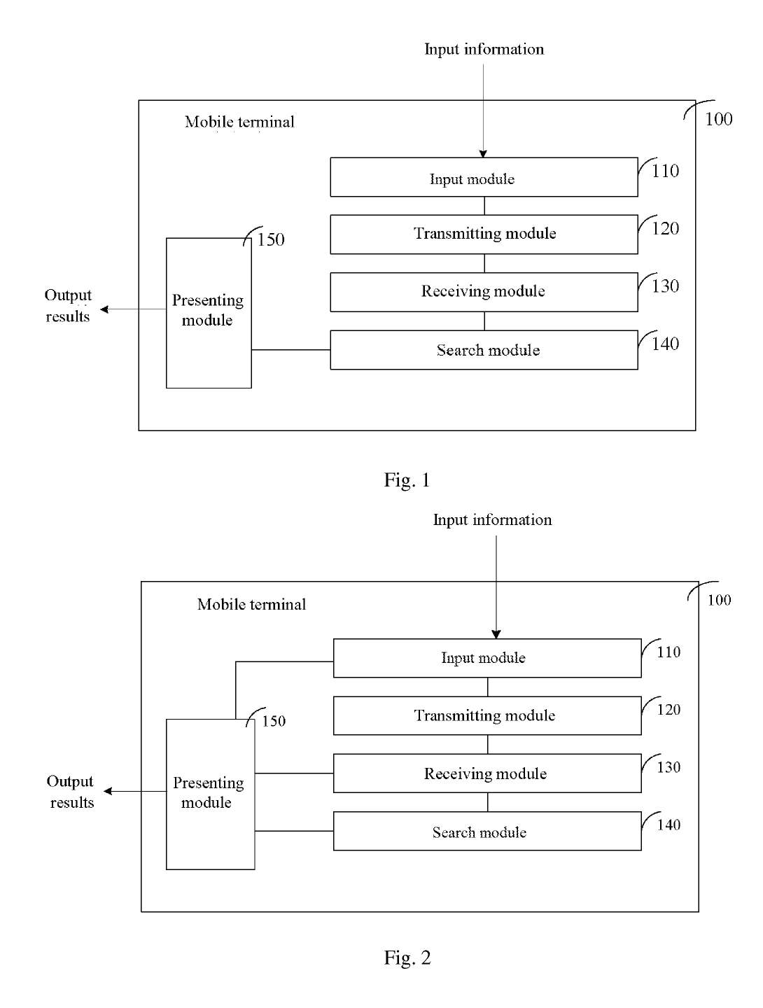

Referring to FIG. 1, it illustrates a structural diagram of a mobile terminal for realizing search according to an embodiment of the disclosure. The mobile terminal 100 includes an input module 110, a transmitting module 120, a receiving module 130, a search module 140 and a presenting module 150.

The input module 110 is configured to receive a keyword for a search.

Furthermore, the mobile terminal 100 further includes a loading module configured to load a network address. The input module 110 uses a regular expression to determine whether the input information is a network address or a keyword, if it is a network address, the input module 110 would instruct the loading module to load the network address; or if it is a keyword, the input module 110 would instruct the transmitting module 120 to transmit the keyword to the server 200. Here is only an exemplified illustration of identifying the keyword from the input information, and in this embodiment the input keyword can be obtained in any way capable of identifying the keyword, for example, a keyword input box is provided directly, and the information input in the keyword input box is identified as a keyword. In this embodiment there is no particular limitation with regards to any specific way of identifying a keyword.

The transmitting module 120 is configured to transmit the keyword received by the input module 110 to the server 200.

The receiving module 130 is configured to receive the recommended search engine selected by the server 200 according to the keyword.

The search module 140 is configured to use the recommended search engine to search for the keyword to obtain search results after receiving the recommended search engine.

The presenting module 150 is configured to present a page of the search results for the search using the search engine recommended by the server 200.

In this embodiment, the mobile terminal transmits the keyword to the server, receives the search engine recommended by the server, uses the search engine to search for the keyword, and presents the search results. Thus, the more appropriate search engine than the default search engine in the prior art can be used with respect to each keyword to make a search to obtain better search results for the keyword.

Moreover, if the receiving module 130 does not receive any reply of the server 200 in a preset length of time, the search module 140 is instructed to use a default search engine to search for the keyword to obtain search results. The presenting module 150 presents the page of the search results obtained by using the default search engine to search for the keyword.

Such a situation may arise in real use that no reply of the server is received due to a network failure or other reasons. Here the default search engine is used to make a search so that the search for keyword can be realized even if the network fails.

Referring to FIG. 2, it illustrates a structural diagram of a mobile terminal for realizing search according to an embodiment of the disclosure. The mobile terminal 100 includes an input module 110, a transmitting module 120, a receiving module 130, a search module 140 and a presenting module 150.

The input module 110 is configured to receive a keyword for a search and an instruction to start an operation.

Furthermore, the mobile terminal 100 further includes a loading module configured to load a network address. The input module 110 uses a regular expression to determine whether the input information is a network address or a keyword, if it is a network address, the loading module is instructed to load the network address; or if it is a keyword, the transmitting module 120 is instructed to transmit the keyword to the server 200. Here is only an exemplified illustration of identifying the keyword from the input information, and in this embodiment the input keyword can be obtained in any way capable of identifying the keyword, for example, a keyword input box is provided directly, and the information input in the keyword input box is identified as a keyword. In this embodiment, there is no particular limitation with regards to any specific way of identifying a keyword.

The transmitting module 120 is configured to transmit the keyword received by the input module 110 to the server 200.

The receiving module 130 is configured to receive the recommended application selected by the server 200 according to the keyword.

The presenting module 150 is configured to present the application recommended by the server 200, when the input module 110 receives an instruction to select the recommended application, instructing the search module 140 to use the application indicated in the instruction to search for the keyword, and presenting the search results after the search results are obtained.

The search module 140 is configured to use the application indicated in the instruction to search for the keyword.

That is, the presenting module 150 presents the application recommended by the server 200; the input module 110 receives the instruction to select the recommended application; the search module 140 uses the application indicated in the instruction to select the recommended application to search for the keyword to obtain the search results; the presenting module 150 further presents the search results obtained by using the application indicated in the instruction to search for the keyword.

Furthermore, when the presenting module 150 presents the recommended applications, scans the applications have been installed locally on the mobile terminal 100, determines the applications which have been installed locally and the applications which are not installed locally among the recommended applications, presents the locally installed applications in a recommended order and thereafter presents the applications which are not installed locally. Thus, when presenting the recommended applications, the applications which have been installed locally are distinguished from the applications which are not installed locally, so as to facilitate the user to select the recommended applications and can make the recommended applications which are not installed locally known to the user, so as to be installed if necessary.

In this embodiment, the mobile terminal transmits the keyword to the server, receives the application recommended by the server, uses the application to search for the keyword according to the instruction, and presents the search results. Thus, more appropriate application than the default search engine in the prior art can be used with respect to each keyword to make a search to thereby obtain better search results for the keyword.

Moreover, if the receiving module 130 does not receive any reply of the server 200 in a preset length of time, it instructs the search module 140 to use a default search engine to search for the keyword to obtain search results. The presenting module 150 presents the page of the search results obtained by using the default search engine to search for the keyword.

Such a situation may arise in real use that no reply of the server is received due to a network failure or other reasons. Here the default search engine is used to make a search so that the search for keyword can be realized even if the network fails.

In an embodiment, the mobile terminal 100 includes an input module 110, a transmitting module 120, a receiving module 130, a search module 140 and a presenting module 150. The individual modules in the mobile terminal 100 are connected as illustrated in FIG. 2.

The input module 110 is configured to receive a keyword for a search and an instruction to start an operation.

Furthermore, the mobile terminal 100 further includes a loading module configured to load a network address. The input module 110 uses a regular expression to determine whether the input information is a network address or a keyword, if it is a network address, the loading module is instructed to load the network address; or if it is a keyword, the transmitting module 120 is instructed to transmit the keyword to the server 200. Here is only an exemplified illustration of identifying the keyword from the input information, and in this embodiment the input keyword can be obtained in any way capable of identifying the keyword, for example, a keyword input box is provided directly, and the information input in the keyword input box is determined as a keyword. In this embodiment, there is no particular limitation with regards to any specific way of identifying a keyword.

The transmitting module 120 is configured to transmit the keyword received by the input module 110 to the server 200.

The receiving module 130 is configured to receive the recommended search engine and application selected by the server 200 according to the keyword.

The search module 140 is configured to use the recommended search engine to search for the keyword to obtain search results after receiving the recommended search engine.

The presenting module 150 is configured to present a page of the search results for the search using the search engine recommended by the server 200 and to present the application recommended by the server 200, and when the input module 110 receives an instruction to select the recommended application, the search module 140 is instructed to use the application indicated in the instruction to search for the keyword, to present search results after the search results are obtained. That is, the presenting module 150 presents both the page of the search results for the search using the recommended search engine and the recommended application at the same time. The input module 110 receives the instruction to select the recommended application. The search module 140 uses the application indicated in the instruction to search for the keyword to obtain the search results. The presenting module 150 further presents the search results obtained from the search by using the application indicated in the instruction.

Furthermore, when the presenting module 150 presents the recommended applications, scans the applications have been installed locally on the mobile terminal 100, determines the applications which have been installed locally and the applications which are not installed locally among the recommended applications, presents the locally installed applications in a recommended order and thereafter presents the applications which are not installed locally. Thus, when presenting the recommended applications, the applications which have been installed locally are distinguished from the applications which are not installed locally, so as to facilitate the user to select the recommended applications and can make the recommended applications which are not installed locally known to the user, so as to be installed if necessary. Furthermore, when the application indicated in the instruction is used to search for the keyword, the search module 140 extracts the keyword from a Uniform Resource Locator (URL) of the presented page of the search results under a URL rule, uses the application indicated in the instruction to search for the keyword to obtain the search results, and instructs the presenting module 150 to present the obtained search results. Here is only one illustrative example of realizing the use of the application indicated in the instruction to search for the keyword. The application indicated in the instruction can be used in an alternative way to search for the keyword, for example, the keyword is stored, the stored keyword is retrieved upon reception of the instruction, and the application indicated in the instruction is used to search for the keyword.

In this embodiment, the mobile terminal transmits the keyword to the server, receives the search engine and the application recommended by the server, uses the search engine to search for the keyword, and presents the search results; and selects the recommended application according to the instruction, uses the selected application to search for the keyword, and presents the new search results. Thus, the more appropriate search engine than a default search engine in the prior art can be used with respect to each keyword to make a search. Moreover, if the search results are not satisfactory, the recommended application can be used flexibly to make a search to thereby obtain better search results for the keyword.

Moreover, if the receiving module 130 does not receive any reply of the server 200 in a preset length of time, it instructs the search module 140 to use a default search engine to search for the keyword to obtain search results. The presenting module 150 presents the page of the search results obtained by using the default search engine to search for the keyword. Such a situation may arise in real use that no reply of the server 200 is received due to a network failure or other reasons. Here the default search engine is used to make a search so that the search for keyword can be realized even if the network fails.

In an embodiment, the presenting module 150 is further configured to present the switch icons of optional search engines, at the time of presenting the page of the search results for the search using the search engine recommended by the server 200 and/or presenting the application recommended by the server 200.

The input module 110 is further configured to receive an instruction to switch to an optional search engine and to transmit the instruction to the search module 140.

The search module 140 is further configured to use the search engine indicated in the instruction to search for the keyword to obtain search results.

The presenting module 150 is further configured to present the search results obtained for the search using the search engine indicated in the instruction.

Furthermore, when the search engine indicated in the instruction is used to search for the keyword, the search module 140 extracts the keyword from a Uniform Resource Locator (URL) of the presented page of the search results under a URL rule, uses the search engine indicated in the instruction to search for the keyword to obtain the search results and instructs the presenting module 150 to present the obtained search results. Here is only one illustrative example of realizing the use of the search engine indicated in the instruction to search for the keyword. The search engine indicated in the instruction can be used in an alternative way to search for the keyword, for example, the keyword is stored, the stored keyword is retrieved upon reception of the instruction, and the search engine indicated in the instruction is used to search for the keyword.

In a typical technical solution of switching a search engine in the art, a search page of a current search engine is switched to a search page of another search engine, and the keyword is input again in the switched-to search page to make a search. Thus, the complexity of the operation may be increased, and brings inconvenience for the user to switch the search engine. By means of the technical solution according to this embodiment, the optional search engines are presented together with the page of the search results and/or the recommended application, and when the search engine is switched, the page is unnecessarily to be switched. Moreover, after the switched-to new search engine is used for search, the keyword is unnecessarily to be input again, and the switched-to search engine uses the keyword directly to make the search, thus simplifies the operation and facilitates the user to switch the search engine.

In an embodiment of the disclosure, after the input module 110 receives the instruction to switch to an optional search engine or to select the recommended application, the transmitting module 120 is further configured to report the search engine or the application indicated in the instruction, and the keyword to the server 200 so that the server 200 updates a database according to the reported information. The correspondence relationship between keywords and search engines and/or the applications is recorded in the database.

In this embodiment, the mobile terminal feeds the selection of the user back to the server so that the server aggregates and analyzes the using condition of the search engine or the application by the user and updates the database. Thus, the search engine and/or the application recommended by the server can match the keyword better so that better search results can be obtained.

In an embodiment, the transmitting module 120 is further configured to transmit the geographical positional information of the mobile terminal 100 to the server 200 when transmitting the keyword to the server 200.

The receiving module 130 is further configured to receive the service application(s), based on the geographical positional information, recommended by the server 200.

The presenting module 150 is further configured to present the service application(s), based on the geographical positional information, recommended by the server 200.

In this embodiment, when reporting the keyword to obtain the recommended search engine and/or application, the mobile terminal can further report the geographical positional information to obtain the recommended service application(s) based on the geographical positional information, so that the user can be provided with a number of applications, the scope of applications that the user can select is broadened.

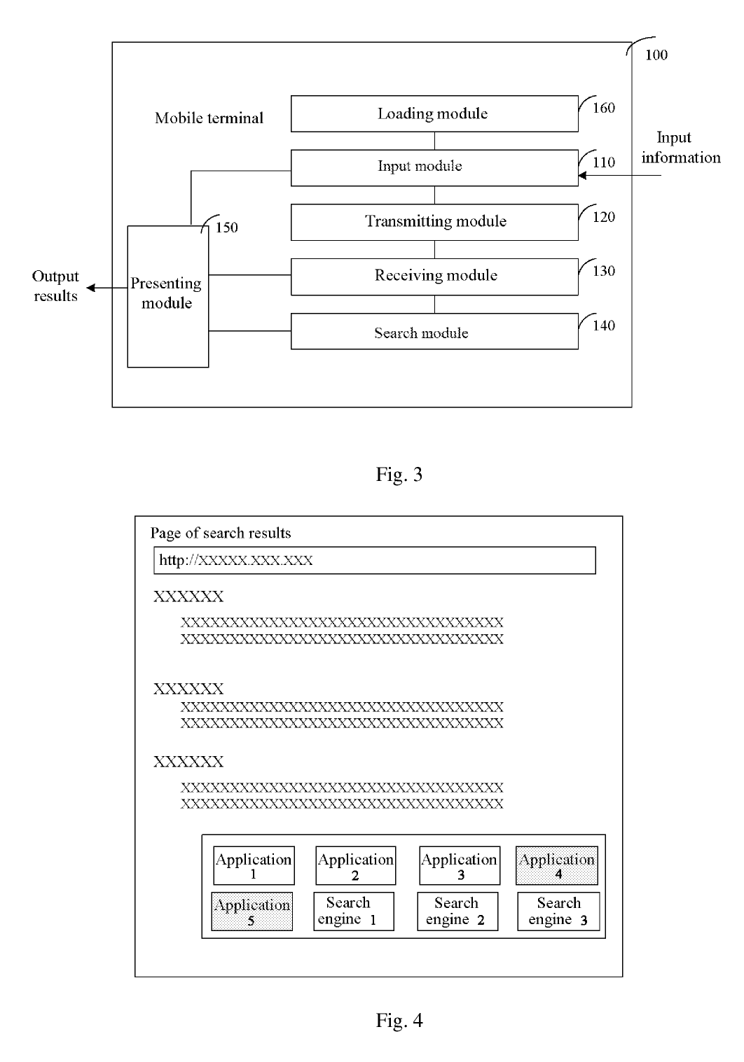

A particular implementation of the mobile terminal according to the embodiment of the disclosure will be described below in details in the following example. FIG. 3 illustrates the structure of the mobile terminal in the example. The mobile terminal 100 includes an input module 110, a transmitting module 120, a receiving module 130, a search module 140, a presenting module 150 and a loading module 160.

The input module 110 receives input information.

The input module 110 uses a regular expression, as illustrated in the RFC 1738, to determine whether the input information is a network address or a keyword, if it is a network address, the input module 110 would instruct the loading module 160 to load the network address; or if it is a keyword, the input module 110 would instruct the transmitting module 120 to transmit the keyword to the server 200.

The transmitting module 120 transmits the keyword received by the input module 110 and the geographical positional information of the mobile terminal 100 to the server 200.

The receiving module 130 determines whether a reply of the server 200 has been received in a preset length of time, and if a reply of the server 200 is received, the receiving module 130 would instruct the search module 140 to use the search engine recommended by the server 200 to make a search; or if no reply of the server 200 is received, the receiving module 130 would instruct the search module 140 to use a default search engine to make a search. The applications recommended by the server 200 include the service application(s) based on the geographical positional information.

The search module 140 makes a search to obtain search results according to the instruction of the receiving module 130.

The presenting module 150 presents the page of the search results of the search module 140, and when the receiving module 130 receives the application recommended by the server 200, the presenting module 150 also presents the application recommended by the server 200, and presents the switch icons of optional search engines.

Particularly, when the presenting module 150 presents the recommended applications, scans the applications have been installed locally on the mobile terminal 100, determines the applications which have been installed locally and the applications which are not installed locally among the recommended applications, presents the locally installed applications in a recommended order and thereafter presents the applications which are not installed locally.

As illustrated in FIG. 4, it illustrates a schematic diagram of the presented interface of the search results. In the interface, the page of the search results is presented, and the recommended applications and the optional search engines are presented in a lower-right part of the page. The applications which are not installed locally are represented in a grey background. The presenting order is in a sequence of the locally installed applications arranged in the recommended order, followed by the recommended applications which are not installed locally, and the optional search engines. When an icon of an application is clicked on, the input module 110 receives an instruction to select the recommended application, where the application indicated in the instruction is the clicked-on application. When an icon of a search engine is clicked on, the input module 110 receives an instruction to switch to the optional search engine, where the search engine indicated in the instruction is the clicked-on search engine.

The input module 110 receives the instruction to select the recommended application or the instruction to switch to an optional search engine. The search module 140 extracts the keyword from a Uniform Resource Locator (URL) of the presented page of the search results under a URL rule, uses the application indicated in the instruction to select the recommended application, or the search engine indicated in the instruction to switch to an optional search engine, to search for the keyword to obtain the search results. The presenting module 150 presents the new search results.

After the input module 110 receives the instruction to switch to an optional search engine or to select the recommended application, the transmitting module 120 reports the search engine or the application indicated in the instruction, and the keyword to the server 200 so that the server 200 updates a database according to the reported information. The correspondence relationship between keywords and search engines and/or the applications is recorded in the database.

Hereinbefore is the detailed description of the mobile terminal according to the embodiment of the disclosure, where the mobile terminal transmits the keyword to the server, receives the search engine and application recommended by the receiver, uses the search engine to search for the keyword, and presents the search results; and selects a recommended application or other optional search engine according to the instruction, uses the selected application or search engine to search for the keyword, and presents the new search results. Thus, the more appropriate search engine than a default search engine in the prior art can be used with respect to each keyword to make a search. Moreover, if the search results are not satisfactory, the recommended application or other search engine can be used flexibly to make a search to obtain better search results for the keyword.

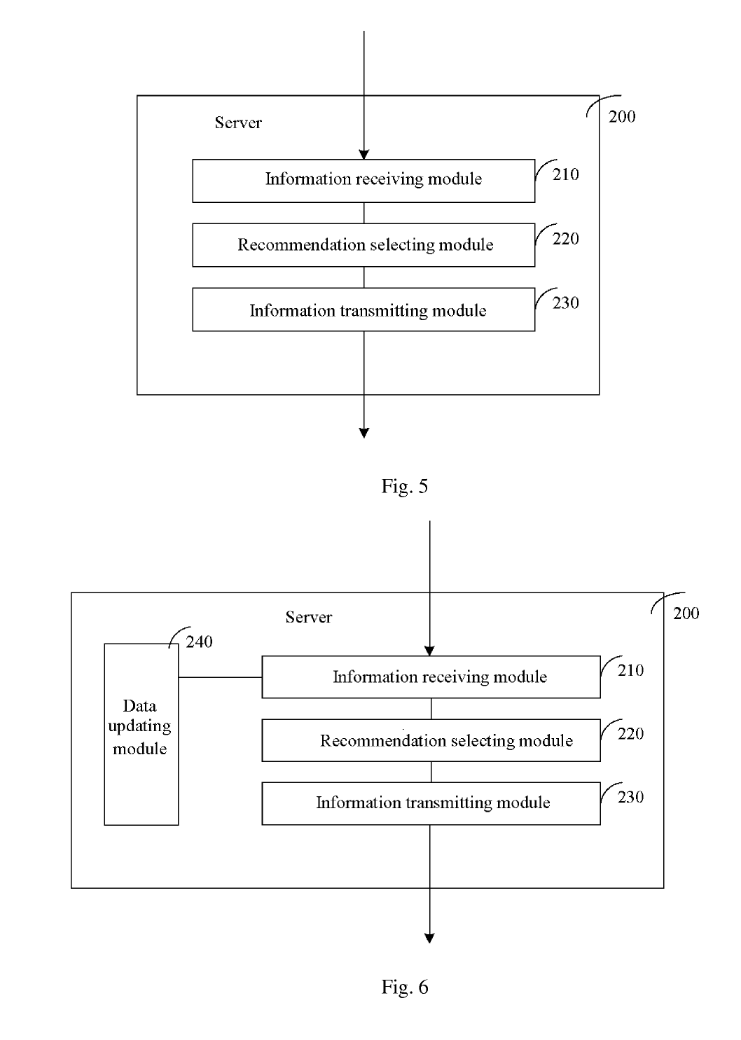

Referring to FIG. 5, it illustrates a structural diagram of a server for realizing search according to an embodiment of the disclosure. The server 200 includes an information receiving module 210, a recommendation selecting module 220 and an information transmitting module 230.

The information receiving module 210 is configured to receive a keyword for a search transmitted by a mobile terminal 100.

The recommendation selecting module 220 is configured to select the recommended search engine and/or application according to the keyword.

The information transmitting module 230 is configured to return the recommended search engine and/or application to the mobile terminal 100.

Furthermore, the recommendation selecting module 220 searches a database for the received keyword, determines the category that the keyword belongs to and selects the recommended search engine and/or application according to the click-through rate (CTR) of the search engine and/or application in the belonged category.

Furthermore, if the recommendation selecting module 220 does not find the keyword in the database, the keyword would be added to a category “Unknown”; and a preset search engine for a general search would be returned to the mobile terminal 100 and/or no recommended application would be returned to the mobile terminal 100.

For example, a data table as below is stored in the database. The data table includes table entries, keywords, categories, search engines and applications, where the categories are the categories that the keywords belong to, and the search engines and the applications are the search engines and applications corresponding to the categories.

Wherein, a search engine has two attributes, a user click-through rate and a category that it belongs to, a category has an attribute of keywords, a keyword has the attributes of search engine and application, and the click-through rate of the search engine and the application. A click-through rate is the number of times of being clicked on in a preset period of time.

TABLE 1

| Categories | Keywords | Search engines | Applications |
|---|---|---|---|
| Weather | Beijing weather | Baidu | Tianqitong/PM2.5 |
| Place Name | Yong He Palace/New | Baidu map/Google | Baidu map/Sogou map/ |
| | Bright Plaza | map/Sogou map | Careland navigation/ |
| | | | Navigation dog |
| Restaurant | Hotpot/movie | Tuan.360, dianping | dianping/Jiepang/buding |
| and | ticket/hot spring/KTV | | coupon/Meituan/55tuan |
| entertainment | | | |
| Shopping | Humidifier/watch/milk | Jingdong/Tao | Jingdong/Taobao/Ju. |
| | powder | bao/Joyo/Dang | Taobao/ |
| | | dang/etao, etc. | Dangdang/Yihaodian/etao, |
| | | | etc. |
| Clothes | Jean/cloth | Taobao/Vancl/Tmall/ | Taobao/Vancl/Tmall/VIP |
| | shoes/T-shirt/satchel | VIP shop | shop |
| Digital home | Ipad/router/soybean | Jingdong/New | Jingdong/New |
| appliance | Milk machine | egg/Dangdang/Suning | egg/Dangdang/ |
| | | | Suning |
| Book | Something in Ming | Douban/Joyo/ | book.Douban/ |
| | Dynasty/Little Prince | Dangdang/Jingdong | Jingdong/Dangdang |
| Music | Old boy/Hong dou | Baidu MP3/Google | Music.Douban/QQ |
| | | music | music/Xia mi music |
| Movie | Chinese good voice/ | so.360kan/ | Youku/tv.Sohu/Douban |
| | Mission Impossible 4 | Douban/Youku | movie |
| Question and | How to modify the | Zhidao.Baidu/ | Zhihu |
| answer | color of background in | wenda.Qihoo | |
| | WORD | | |
| Foreign | Chinese/ [symbol] | Fanyi.youdao/ | translate.google/Sogou |
| language | | translate.google | translate |
| Nomenclature | Ipv6/ Plantain/ [symbol] | Baidu | Great Encyclopedia |
| | (Hanhan)/ [symbol] (NPC | cyclopedia/Interactive | |
| | and CPPCC) | cyclopedia/Wiki | |
| | | cyclopedia | |
| News | Opening of Olympic | Baidu news/People's | Netease news/Baidu news/ |
| | Games/Opening of | network/Netease | iFeng focus |
| | new subway line | | |
| Tourism | Airline | Trip.Taobao/Ctrip/Ma | Trip.Taobao/Ctrip |
| | ticket/hotel/Entry ticket | feng wo/Lvmama | wireless/tourism |
| | | | guider/hotel expert |
| Others | Microblog/Government | Sina microblog | Sina micro blog/Netease |
| | work report | search/Baidu | microblog |
| | | cyclopedia/Google | |

When the recommendation selecting module 220 selects the recommended search engine and application(s) for a keyword after receiving the keyword, the selection is carried out by the following particular embodiment. Searching the database for the keyword, and if it is found, then determining the category of the keyword, going through click-through rates of the search engines and the application(s) in the category, selecting the search engine with the highest click-through rate for recommendation as the recommended search engine, and selecting a preset number of applications in an order of descending click-through rate as the recommended applications. If the keyword is not found in the database, then the recommendation selecting module 220 adds the keyword to a category “Unknown”, returns a preset search engine for a general search to the mobile terminal 100 and will not return any recommended application to the mobile terminal 10.

Furthermore, the information receiving module 210 is further configured to receive geographical positional information of the mobile terminal 100 transmitted by the mobile terminal 100; and the information transmitting module 230 is further configured to transmit the recommended service application(s) based on the geographical positional information to the mobile terminal 100.

In this embodiment, the search engine and/applications corresponding to the keyword are returned to the mobile terminal so that the mobile terminal uses the more appropriate search engine or application to make a search to thereby obtain better search results.

In an embodiment of the disclosure, referring to FIG. 6, it illustrates a structural diagram of a server for realizing search according to an embodiment of the disclosure. The server 200 includes an information receiving module 210, a recommendation selecting module 220, an information transmitting module 230 and a data updating module 240.

The information receiving module 210 is configured to receive a keyword for a search transmitted by a mobile terminal 100 and the information reported by the mobile terminal 100. The information includes the search engine or the application indicated in an instruction received by the mobile terminal 100, and the keyword.

The data updating module 240 is configured to update the category of the keyword, and click-through rate of the search engine(s) and/or application(s) in the category, in a database, according to the reported information.

The recommendation selecting module 220 is configured to select the recommended search engine and/or application according to the keyword.

The information transmitting module 230 is configured to return the recommended search engine and/or application to the mobile terminal 100.

For example, the information reported by the mobile terminal is the keyword+the search engine/application. The corresponding category that the keyword belongs to is determined according to the search engine, and since there are different selections by respective users, the category that the keyword belong to may change continuously accordingly on a basis that the keyword+the number of times that the search engines are selected by the users. Moreover, in order to determine more accurately the category of the keyword, adjustment can be applied, for example, by setting an adjustment weight of 99% so that the reported information is weighted by 1%. Moreover, the click-through rate of the search engine and the application are updated according to the reported information.

In this embodiment, the server receives the information reported by the mobile terminal, aggregates and analyzes the use of the search engine or the application by the user and updates the database. Thus the search engine and/or the application recommended by the server can better match the keyword so that better search results can be obtained.

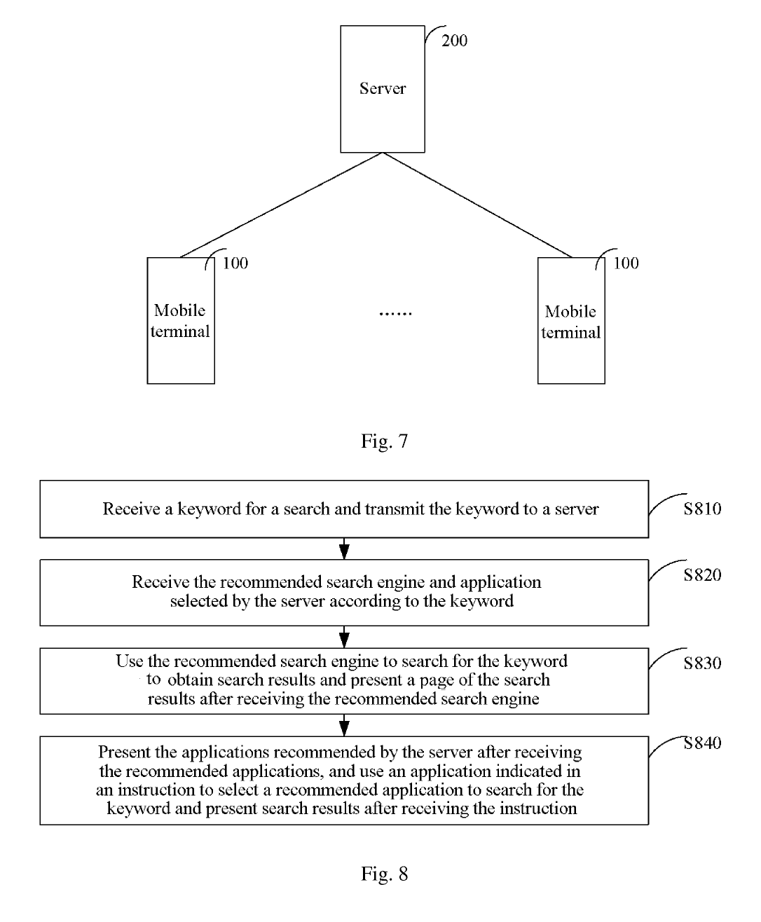

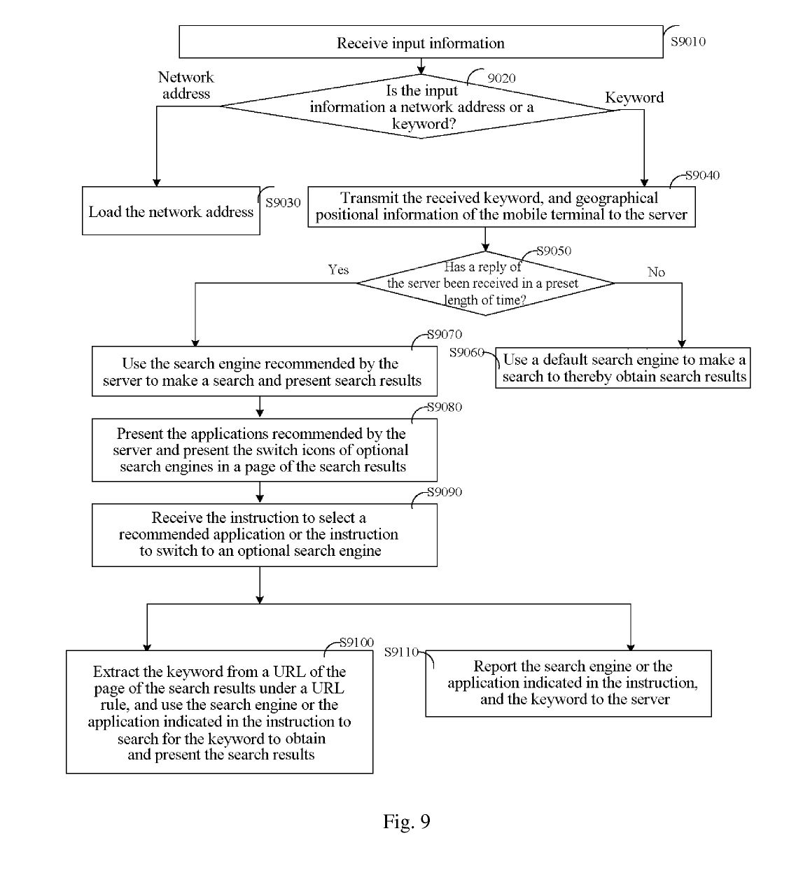

Referring to FIG. 7, it illustrates a structural diagram of a system for realizing search according to an embodiment of the disclosure.

The system includes the server 200 and a plurality of mobile terminals 100. The server 200 can be connected with the mobile terminals 100 directly or over various networks, and the embodiment of the disclosure will not be limited in this regard.

FIG. 8 illustrates a flow chart of a method for realizing search in a mobile terminal according to an embodiment of the disclosure. The method includes the following steps.

The step S810 is to receive a keyword for a search and to transmit the keyword to a server.

Furthermore, the step S810 particularly includes: uses a regular expression to determine whether the input information is a network address or a keyword, and if it is a network address, loads the network address; or if it is a keyword, transmits the keyword to the server. Here is only an illustrative example identifying the keyword from the input information, and the input keyword can be obtained in this embodiment in any way capable of identifying the keyword, for example, a keyword input box is provided directly, and the information input in the keyword input box is determined as a keyword. This embodiment will not be limited particularly to any way of identifying a keyword.

The step S820 is to receive the recommended search engine and application selected by the server according to the keyword.

Furthermore, if no reply of the server is received in a preset length of time, a default search engine would be used to search for the keyword to obtain search results, and the search results are presented. Such a situation may arise in real use that no reply of the server will be received due to a network failure or other reasons. Here the default search engine is used to make a search so that the keyword could be searched even if the network fails.

The step S830 is to use the recommended search engine to search for the keyword to obtain search results and to present a page of the search results after receiving the recommended search engine.

The step S840 is to present the applications recommended by the server after receiving the recommended applications, and to use the application indicated in an instruction to select a recommended application to search for the keyword and to present search results after receiving the instruction.

Furthermore, the using the application indicated in the instruction to search for the keyword particularly includes: extracting the keyword from a Uniform Resource Locator (URL) of the presented page of the search results under a URL rule, using the search engine indicated in the instruction to search for the keyword to obtain the search results and presenting the search results. Here is only an illustrative example of using the application indicated in the instruction to search for the keyword. Alternatively, the application indicated in the instruction can be used otherwise to search for the keyword, for example, the keyword is stored, the stored keyword is retrieved after receiving the instruction, and the application indicated in the instruction is used to search for the keyword.

Furthermore, the presenting the applications recommended by the server particularly includes: scanning for applications installed locally on the mobile terminal, determining the applications which have been installed locally and the applications which are not installed locally among the recommended applications, presenting the locally installed applications in an order that they are recommended and thereafter presenting the applications which are not installed locally. Thus, when presenting the recommended applications, the applications which have been installed locally is distinguished from the applications which are not installed locally so as to facilitate the user to select the recommended applications and make the recommended applications which are not installed locally known to the user so as to be installed if necessary.

Moreover, the method can further include: transmitting geographical positional information of the mobile terminal to the server at the time of presenting the keyword; receiving a service application, based on the geographical positional information, recommended by the server and presenting the service application(s) based on the geographical positional information. In addition to reporting the keyword to obtain the recommended search engine and/or application, the mobile terminal can further report the geographical positional information to obtain the recommended service application(s) based on the geographical positional information, so that the user can be provided with a number of applications, the scope of applications that the user can select is broadened.

In this embodiment, the mobile terminal transmits the keyword to the server, receives the search engine and application recommended by the server, uses the search engine to search for the keyword and presents the search results; and selects the recommended applications according to the instruction, uses the selected application to search for the keyword and presents the new search results. Thus, the more appropriate search engine than a default search engine in the prior art can be used in correspondence to each keyword to make a search. Moreover, if the search results are not satisfactory, the recommended application can be used flexibly to make a search to thereby obtain better search results for the keyword.

The embodiment above is merely illustrative of the disclosure, and the information reported by the server may not necessarily include both the search engine and the application but may include the search engine or the application. If the recommended search engine selected by the server according to the keyword is received in the step S820, then only the step S830 will be performed without performing the step S840 to present the recommended applications. If the recommended application selected by the server according to the keyword is received in the step S820, then the step S830 will not be performed to use the recommended search engine to search for the keyword, while the step S840 will be performed directly after the step S820 to present the recommended applications, and use an application to search for the keyword according to the instruction.

In an embodiment of the disclosure, the method further includes: presenting the switch icons of optional search engines at the time of presenting the page of the search results for the search using the search engine recommended by the server and/or the application recommended by the server. After receiving an instruction to switch to an optional search engine, the search engine indicated in the instruction is used to search for the keyword to obtain search results, and the search results are presented.

Furthermore, the keyword is extracted from a Uniform Resource Locator (URL) of the presented page of the search results under a URL rule, the search engine indicated in the instruction is used to search for the keyword to obtain the search results, and the obtained search results are presented. Here is only an illustrative example of using the search engine indicated in the instruction to search for the keyword. Alternatively, the search engine indicated in the instruction can be used otherwise to search for the keyword, for example, the keyword is stored, the stored keyword is retrieved after receiving the instruction, and the search engine indicated in the instruction is used to search for the keyword.

In a typical technical solution of switching a search engine in the art, a search page of a current search engine is switched to a search page of another search engine, and the keyword is input again in the switched-to search page to make a search. Thus, the complexity of the operation may be increased, and brings inconvenience to the user to switch the search engine. With the technical solution according to this embodiment, the optional search engines are presented together with the page of the search results and/or the recommended application at the same time, and the search engine can be switched without switching the page. Moreover, after the search is made in the switched-to new search engine, the keyword is not required to be input again, the switched-to search engine will use the keyword directly to make the search, thus simplifies the operation and facilitates the user to switch the search engine.

In an embodiment of the disclosure, the method further includes: after receiving the instruction to switch to an optional search engine or to select a recommended application, reporting the search engine or the application indicated in the instruction, and the keyword to the server so that the server updates a database according to the reported information, where the correspondence relationship between keywords and search engines and/or the applications is recorded in the database.

In this embodiment, the mobile terminal feeds the selection by the user back to the server so that the server aggregates and analyzes the using condition of the search engines or the applications by the user and updates the database. Thus the search engine and/or the application recommended by the server can better match the keyword so that better search results can be obtained.

A particular implementation of the method for realizing search in a mobile terminal according to the embodiment of the disclosure will be described below in details in the following example.

The step S9010 is to receive input information.

The step S9020 is to use a regular expression, as illustrated in the RFC 1738, to determine whether the input information is a network address or a keyword, and if it is a network address, to proceed to the step S9030; or if it is a keyword, to proceed to the step S9040.

The step S9030 is to load the network address.

The step S9040 is to transmit the received keyword, and geographical positional information of the mobile terminal to the server.

The step S9050 is to determine whether a reply of the server has been received in a preset length of time, and if a reply of the server is received, to proceed to the step S9070; otherwise, to proceed to the step S9060. The applications recommended by the server include the service application(s) based on the geographical positional information.

The step S9060 is to use a default search engine to make a search to thereby present search results.

The step S9070 is to use the search engine recommended by the server to make a search and to present search results, and to proceed to the step S9080.

The step S9080 is to present the applications recommended by the server and the switch icons of optional search engines in a page of the search results, and thereafter to proceed to the step S9090.

Particularly, when the recommended applications are presented, scans the applications installed locally on the mobile terminal, determines the applications which are installed locally and the applications which are not installed locally among the recommended applications, presents the locally installed applications in an order that they are recommended and thereafter presents the applications which are not installed locally.

As illustrated in FIG. 4, it illustrates a schematic diagram of the presented interface of the search results. In the interface, the page of the search results is presented, and the recommended applications and the optional search engines are presented in a lower-right part of the page. The applications which are not installed locally are represented in a grey background. They presenting order is in a sequence of the locally installed application arranged in the recommended order, followed by the recommended applications which are not installed locally, and the optional search engines. When an icon of application is clicked on, an instruction to select a recommended application is received, where the application indicated in the instruction is the clicked-on application. When an icon of search engine is clicked on, an instruction to switch to the optional search engine is received, where the search engine indicated in the instruction is the clicked-on search engine.

The step S9090 is to receive the instruction to select a recommended application or the instruction to switch to an optional search engine and to proceed to the step S9100 and the step S9110.

The step S9100 is to extract the keyword from a Uniform Resource Locator (URL) of the presented page of the search results under a URL rule, to use the search engine or the application indicated in the instruction to search for the keyword to obtain the search results and to present the new search results.

The step S9110 is to report the search engine or the application indicated in the instruction, and the keyword to the server, so that the server updates the database according to the reported information. A correspondence relationship between the keyword and the search engine and/or the application is recorded in the database.

The method for realizing search in a mobile terminal according to the embodiment of the disclosure has been described above in details, where the mobile terminal transmits the keyword to the server, receives the search engine and the applications recommended by the receiver, uses the search engine to search for the keyword and presents the search results; and selects the recommended applications or other optional search engine(s) according to the instruction, uses the selected application or search engine to search for the keyword, and presents the new search results. Thus, the more appropriate search engine than a default search engine in the prior art can be used with respect to each keyword to make a search. Moreover, if the search results are not satisfactory, then the recommended application or other search engine can be used flexibly to make a search to obtain better search results for the keyword.

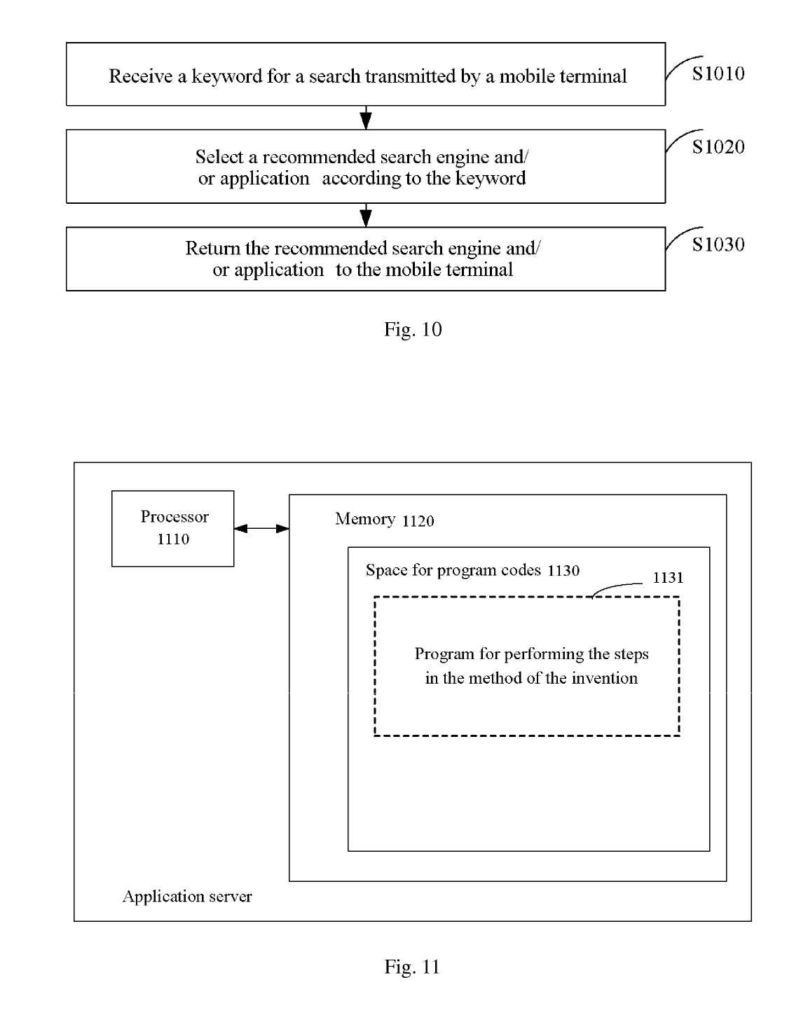

Referring to FIG. 10, it illustrates a flow chart of a method for realizing search in a mobile terminal according to an embodiment of the disclosure, where the method includes the following steps:

The step S1010 is to receive a keyword for a search transmitted by a mobile terminal.

The step S1020 is to select the recommended search engine and/or application according to the keyword.

The step S1030 is to return the recommended search engine and/or application to the mobile terminal.

Furthermore, the step S 1020 particularly includes: searching a database for the keyword, determining the category that the keyword belongs to and selecting the recommended search engine and/or application according to the click-through rate of the search engine and/or applications in the category.

Furthermore, the searching the database for the keyword further includes: if the keyword is not found in the database, then adding the keyword to a category “Unknown”; and returning a preset search engine for a general search to the mobile terminal and/or not returning any recommended application to the mobile terminal.

For example, the data table depicted in Table 1 is stored in the database. The data table includes table entries, keywords, categories, search engines and applications, where the categories are the categories that keywords belong to, and the search engines and the applications are search engines and applications corresponding to the categories.

Wherein, a search engine has two attributes, a user click-through rate and a category that it belongs to. A category has an attribute of a keyword. A keyword has attributes of a search engine and an application, and the click-through rate of the search engine and the application. A click-through rate is the number of times of being clicked on in a preset period of time.

When the server selects the recommended search engine and application for the keyword after receiving the keyword, the selection is carried out by the following particular embodiment. Searching the database for the keyword, and if it is found, then determining the category of the keyword, going through click-through rate of the search engines and the applications in the category, selecting the search engine with the highest click-through rate for recommendation as the recommended search engine, and selecting a preset number of applications in an order of descending click-through rate as the recommended applications. If the keyword is not found in the database, then adds the keyword to a category “Unknown”, and a preset search engine for a general search is returned to the mobile terminal without returning any recommended application to the mobile terminal.

Furthermore, the method further includes: receiving geographical positional information of the mobile terminal transmitted by the mobile terminal; and transmitting a recommended service application(s) based on the geographical positional information to the mobile terminal.

In this embodiment, the search engine and/applications corresponding to the keyword are returned to the mobile terminal, so that the mobile terminal uses the more appropriate search engine or application to make a search to obtain better search results.

In an embodiment, the method further includes: receiving the information reported by the mobile terminal, where the information includes the search engine or application indicated in an instruction received by the mobile terminal, and the keyword; and updating the category that the keyword belongs to in the database, and the click-through rate of search engine(s) and/or application(s) in the category, according to the reported information.

For example, the information reported by the mobile terminal is the keyword+the search engine/application. The corresponding category that the keyword belongs to is determined according to the search engine, and since there are different selections by respective users, the category that the keyword belong to may change continuously accordingly on a basis that the keyword+the number of times that the search engines are selected by the users. Moreover, in order to determine more accurately the category of the keyword, adjustment can be applied, for example, by setting an adjustment weight of 99% so that the reported information is weighted by 1%. Moreover, the click-through rate of the search engine and the application are updated according to the reported information.

In this embodiment, the server receives the information reported by the mobile terminal, aggregates and analyzes the use of the search engine or the application by the user and updates the database. Thus the search engine and/or the application recommended by the server can better match the keyword so that better search results can be obtained.

It shall be noted that the embodiments of the disclosure and features in the embodiments can be combined with each other in any combination unless there is confliction between them.

The respective components in the embodiments of the disclosure can be embodied in hardware or in software modules running on one or more processors or in a combination of both. Those skilled in the art shall appreciate that some or all of the functions of some or all of the components in the system for searching over a network according to the embodiment of the disclosure can be performed by a microprocessor or a Digital Signal Processor (DSP) in practice. The disclosure can be further embodied as a device or apparatus program (e.g., computer program and a computer program product) for performing a part or all of the method described here. Such program in which the disclosure is embodied can be stored on a computer readable medium or in the form of one or more signals. Such a signal or signals can be downloaded from an Internet website or provided on a carrier signal or in any other form.

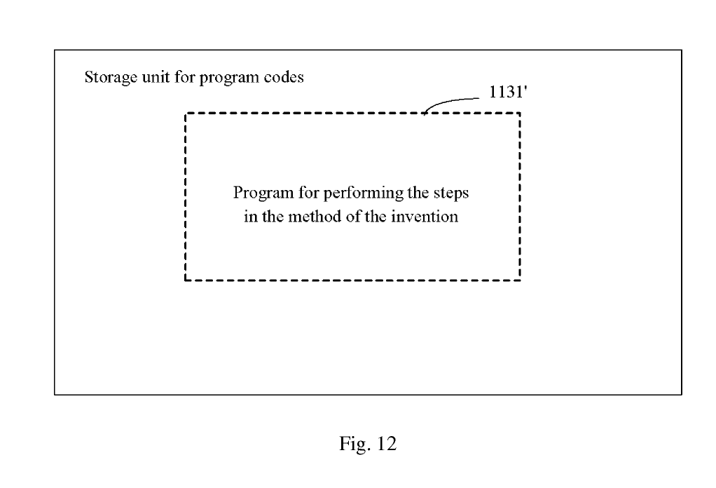

For example, FIG. 11 illustrates a server for providing a mobile terminal with a search according to an embodiment of the disclosure, e.g., an application server. The server generally includes a processor 1110, and a computer program product or a computer readable medium in the form of a memory 1120, which can be, e.g., a flash memory, an Electrical Erasable Programmable Read Only Memory (EEPROM), an EPROM, a hard disk, an ROM or other electronic memories. The memory 1120 includes a storage space 1130 in which there are stored program codes 1131 for performing the steps in any of the methods above. For example, the storage space 1130 for the program codes can include respective program codes 1131 for performing the respective steps in the method above respectively. These program codes can be read from or written into one or more computer program products which include, e.g., a hard disk, a Compact Disk (CD), a memory card, a floppy disk or other program code carriers. Such a computer program product or products are typically portable or fixed storage units as illustrated in FIG. 12. The storage units can include storage segments, storage spaces, etc., arranged as in the memory 1120 in the server illustrated in FIG. 11. The program codes can be compressed in an appropriate form, for example. Typically the storage units include computer readable codes 1131′, i.e., codes which can be read by, e.g., 1110 or other processors, and when these codes are executed by the server, they cause the server to perform the respective steps in the method described above.

“One embodiment”, “an embodiment” or “one or more embodiments” as referred to in this context means that a particular feature, structure or characteristic described on the embodiment is included in at least one embodiment of the disclosure. Moreover it shall be noted that all the instances of “in an embodiment” here may not necessarily refer to the same embodiment.

Numerous particular details have been described in the description here. However it shall be noted that the embodiments of the disclosure can be put into practice without these particular details. Well-known methods, structures and technologies have not been described in details in some embodiments so as not to obscure the understanding of the specification.

It shall be noted that the embodiments above are intended to illustrate but not to limit the disclosure, and those skilled in the art can devise alternative embodiments without departing from the scope of the appended claims. Any reference numerals placed in parentheses in the claims shall not be construed as limiting the claims. The term “comprises/comprising” shall not prelude an element or step which has not been listed in the claims. The term “a/an” preceding an element shall not prelude the presence of a plurality of such elements. The disclosure can be embodied in hardware including several different elements and/or in an appropriately programmed computer. In a device claim listing several means, several of these means can be embodied particularly in the same item of hardware. The use of the terms “first”, “second”, “third”, etc., shall not suggest any order. These terms can be interpreted as nouns.

Moreover, it shall be further noted that the languages used in the specification are selected primarily for the purpose of intelligibility and teaching but selected to explain or limit the subject of matter of the disclosure. Thus numerous modifications and variations will become obvious to those ordinarily skilled in the art without departing from the scope and sprit of the appended claims. The disclosure of the disclosure is merely illustrative but not intended to limit the scope of the disclosure as defined in the appended claims.

1. A mobile terminal, comprising:
an input module configured to receive a keyword for a search;
a transmitting module configured to transmit the keyword to a server;
a receiving module configured to receive a recommended search engine and/or application selected by the server according to the keyword;
a search module configured to use the recommended search engine to search for the keyword to obtain search results after receiving the recommended search engine; and
a presenting module configured to present the page of the search results for the search using the search engine recommended by the server;
and/or to present the application recommended by the server, when the input module receives the instruction to select the recommended application, instructing the search module to use the application indicated in the instruction to search for the keyword, and after the search results are obtained, presenting the search results.

2. The mobile terminal according to claim 1, wherein:
the presenting module is further configured to present the switch icons of optional search engines, at the time of presenting the page of the search results for the search using the search engine recommended by the server and/or presenting the application recommended by the server;
the input module is further configured to receive an instruction to switch to an optional search engine and to transmit the instruction to the search module;
the search module is further configured to use the search engine indicated in the instruction to search for the keyword to obtain search results; and
the presenting module is further configured to present the search results obtained for the search using the search engine indicated in the instruction.

3. The mobile terminal according to claim 2, wherein:
when the input module receives the instruction to switch to an optional search engine or to select a recommended application, the transmitting module is further configured to report the search engine or the application indicated in the instruction, and the keyword to the server, so that the server updates a database according to the reported information; and
a correspondence relationship between keywords and the search engines and/or the applications is recorded in the database.

4. The mobile terminal according to claim 1, wherein:
the transmitting module is further configured to transmit the geographical positional information of the mobile terminal to the server when transmitting the keyword to the server;
the receiving module is further configured to receive the service application(s), based on the geographical positional information, recommended by the server; and
the presenting module is further configured to present the service application(s), based on the geographical positional information, recommended by the server.

5. The mobile terminal according to claim 1, wherein:
the mobile terminal further comprises a loading module configured to load a network address; and
the input module is configured to use a regular expression to determine whether the input information is a network address or a keyword, and if it is a network address, to instruct the loading module to load the network address; or if it is a keyword, to instruct the transmitting module to transmit the keyword to the server.

6. The mobile terminal according to claim 1, wherein:
the presenting module is configured to scan the applications installed locally on the mobile terminal, to determine the applications which have been installed locally and the applications which are not installed locally among the recommended applications, and to present the locally installed applications in a recommended order followed by the applications which are not installed locally.

7. The mobile terminal according to claim 1, wherein:
the receiving module is further configured to, if no reply of the server has been received in a preset length of time, instruct the search module to use a default search engine to search for the keyword to obtain search results; and
the presenting module is further configured to present a page of the search results obtained by using the default search engine to search for the keyword.

8. The mobile terminal according to claim 1, wherein:
when the search engine or the application indicated in the instruction is used to search for the keyword, the search module is configured to extract the keyword from a Uniform Resource Locator (URL) of the presented page of the search results under a URL rule, to use the search engine or the application indicated in the instruction to search for the keyword to obtain the search results and to instruct the presenting module to present the search results.

9. A server, comprising:
an information receiving module configured to receive a keyword for a search transmitted by a mobile terminal;
a recommendation selecting module configured to select the recommended search engine and/or application according to the keyword; and
an information transmitting module configured to return the recommended search engine and/or application to the mobile terminal.

10. The server according to claim 9, wherein:
the recommendation selecting module is configured to search a database for the keyword, to determine the category that the keyword belongs to and to select the recommended search engine and/or application according to click-through rate of the search engine and/or application in the category.

11. The server according to claim 10, wherein:
the recommendation selecting module is configured to, if the keyword is not found in the database, add the keyword to a category “Unknown”; and
returning a preset search engine for a general search to the mobile terminal and/or not returning any recommended application to the mobile terminal.

12. The server according to claim 9, wherein:
the server further comprises a data updating module;
the information receiving module is further configured to receive information reported by the mobile terminal, wherein the information comprises the search engine or application indicated in an instruction received by the mobile terminal, and the keyword; and
the data updating module is configured to update the category that the keyword belongs to, and the click-through rate of the search engine(s) and/or application(s) in the category, in a database according to the reported information.

13-14. (canceled)

15. A method for realizing search in a mobile terminal, comprising:
receiving a keyword for a search and transmitting the keyword to a server;
receiving a recommended search engine and/or application selected by the server according to the keyword;
using the recommended search engine to search for the keyword to obtain search results and presenting a page of the search results after receiving the recommended search engine; and/or
presenting the applications recommended by the server, and after receiving an instruction to select a recommended application, using the application indicated in the instruction to search for the keyword and presenting search results.

16. The method according to claim 15, wherein the method further comprises:
presenting the switch icons of optional search engines at the time of presenting the page of the search results for the search using the search engine recommended by the server and/or presenting the application recommended by the server; and
after receiving an instruction to switch to an optional search engine, using the search engine indicated in the instruction to search for the keyword to obtain search results and presenting the search results.

17. The method according to claim 16, wherein the method further comprises:
after receiving the instruction to switch to a optional search engine or to select a recommended application, reporting the search engine or the application indicated in the instruction, and the keyword to the server so that the server updates a database according to the reported information, wherein correspondence relationship between keywords and search engines and/or the applications is recorded in the database.

18. The method according to claim 15, wherein the method further comprises:
transmitting geographical positional information of the mobile terminal to the server when transmitting the keyword to the server; and
receiving the service application(s), based on the geographical positional information, recommended by the server and presenting the application(s).

19. The method according to claim 15, wherein the receiving the keyword for a search and transmitting the keyword to the server further comprises:
using a regular expression to determine whether the input information is a network address or a keyword, and if it is a network address, then loading the network address; or if it is a keyword, then transmitting the keyword to the server.

20. The method according to claim 15, wherein the presenting the applications recommended by the server further comprises:
scanning the applications installed locally on the mobile terminal, determining the applications which have been installed locally and the applications which are not installed locally among the recommended applications, and presenting the locally installed applications in a recommended order followed by the applications which are not installed locally.

21. The method according to claim 15, wherein the transmitting the keyword to the server further comprises:
if no reply of the server has been received in a preset length of time, then using a default search engine to search for the keyword to obtain search results and presenting the search results.

22. The method according to claim 15, wherein the using the search engine or the application indicated in the instruction to search for the keyword further comprises:
extracting the keyword from a Uniform Resource Locator (URL) of the presented page of the search results under a URL rule, using the search engine or the application indicated in the instruction to search for the keyword to obtain the search results and presenting the search results.

23-29. (canceled)
